(19) United States
(12) Patent Application Publication
(10) Pub. No.: US 2025/0307611 A1
(43) Pub. Date: Oct. 2, 2025

(54) MANAGING INFERENCE MODELS IN VIEW OF ANOMALY CONDITIONS

(71) Applicant: Dell Products L.P., Round Rock, TX (US)

(72) Inventors: LEV MAKLER, Be'er Sheva (IL); OFIR EZRIELEV, Be'er Sheva (IL); ANAT PARUSH TZUR, Tel Aviv (IL); AMIHAI SAVIR, Newton, MA (US)

(21) Appl. No.: 18/622,039

(22) Filed: Mar. 29, 2024

(51) Int. Cl. G06N 3/0455; G06N 3/09

(52) U.S. Cl. CPC G06N 3/0455; G06N 3/09

(57) ABSTRACT

Methods and systems for managing an inference model are disclosed. Input data usable to generate a prediction using the inference model may be obtained from one or more data sources. An anomaly condition associated with the input data may be identified using a classification model. The anomaly condition may be ingested into an attention mechanism of the inference model to obtain an updated inference model. Using the updated inference model and the input data, the generated prediction may be contextualized with respect to the anomaly condition. The prediction may be used, at least in part to provide a computer-implemented service.

### FIELD

Embodiments disclosed herein relate generally to managing inference models. More particularly, embodiments disclosed herein relate to systems and methods to manage the inference models in view of anomaly conditions that may impact predictions of the inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show data flow diagrams in accordance with an embodiment.

FIG. 3 shows a flow diagram illustrating a method for managing inference models based on anomaly conditions in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing an inference model. The inference model may be used to provide computer-implemented services. For example, during an inferencing process, an inference model may generate inferences such as predictions regarding future outcomes, based on time series data (e.g., ingest data). Downstream consumers of the inferences may rely on the quality of the inferences in order to make important decisions based on the predicted future outcomes. However, the ingest data may include data anomalies that, if included during the inferencing process, may affect the quality of the predictions.

For example, data anomalies included in the ingest data that are due to poor data quality (e.g., erroneous or irrelevant data samples) and/or malicious attacks (e.g., purposely misleading data samples) may have a negative impact on the quality of the predictions if used during inferencing.

However, data anomalies included in the ingest data that are due to anomaly conditions (e.g., war, famine, pestilence, material scarcity) occurring over a duration of time may provide context to the ingest data. These data anomalies and their context may be used to improve the quality of the predictions when taken into account during inferencing.

For example, the data anomalies may reflect conditions (e.g., events, circumstances) that may recur over time and that may impact business operations. Therefore, by retaining these data anomalies and by using the anomaly conditions to manage how the inference model analyzes different ingest data features (e.g., in context of the anomaly conditions), the inference model may be more likely to provide trustworthy predictions usable to optimize business goals when the conditions recur.

Thus, to increase the likelihood of providing high-quality predictions to downstream consumers, anomaly conditions that may be present in portions of ingest data may be identified and used to contextualize predictions generated by inference models with respect to the anomaly conditions.

To identify anomaly conditions associated with (portions of) the ingest data, an anomaly classifier may detect anomalies (e.g., a data anomalies) in the ingest data and classify the detected anomalies by anomaly condition. To generate predictions in context of the anomaly condition using an inference model, attention data (e.g., the anomaly condition and/or other information) may be provided to an attention mechanism of the inference model. The attention mechanism may evaluate the attention data in order to update the inference model so that the updated inference model is able to generate predictions in context of the anomaly condition based on the ingest data.

By doing so, embodiments disclosed herein may provide a system for managing inference models in a manner that improves the quality and/or reliability of predictions obtained using the inference models. The improvement in the quality and/or reliability of the predictions may increase the likelihood of providing desired computer-implemented services.

In an embodiment, a method for managing an inference model is provided. The method may include: obtaining input data from one or more data sources to generate a prediction using the inference model; obtaining an anomaly condition associated with the input data, the anomaly condition being identified using an anomaly classifier; ingesting the anomaly condition into an attention mechanism of the inference model to obtain an updated inference model; obtaining the prediction using the updated inference model and the input data; and, providing a computer-implemented service based, at least in part, on the prediction.

The anomaly condition may include one selected from a group of anomaly conditions consisting of: war; inflation; pestilence; famine; poverty; overabundance of material comfort; material scarcity; and, supply chain failure.

The anomaly classifier may be trained to detect an anomaly in the input data and/or classify the anomaly by the anomaly condition.

The inference model may be a neural network, the neural network being trained using a transformer architecture. Ingesting the anomaly condition may include modifying weights of the neural network based on the anomaly condition to obtain the updated inference model.

The weights may modify importance of different features of the input data on predictions generated by the updated inference model. Modifying the weights may contextualize the prediction with respect to the anomaly condition.

The attention mechanism may impact operation of an input layer of the neural network. The attention mechanism may impact operation of at least one hidden layer of the neural network.

The prediction may include information usable to manage a condition impacting a business at a future point in time. The condition impacting the business at the future point in time may be a change in availability of supply of a product from a supplier.

A non-transitory media may include instructions that when executed by a processor cause the computer-implemented method to be performed.

A data processing system may include the non-transitory media and a processor, and may perform the computer-implemented method when the computer instructions are executed by the processor.

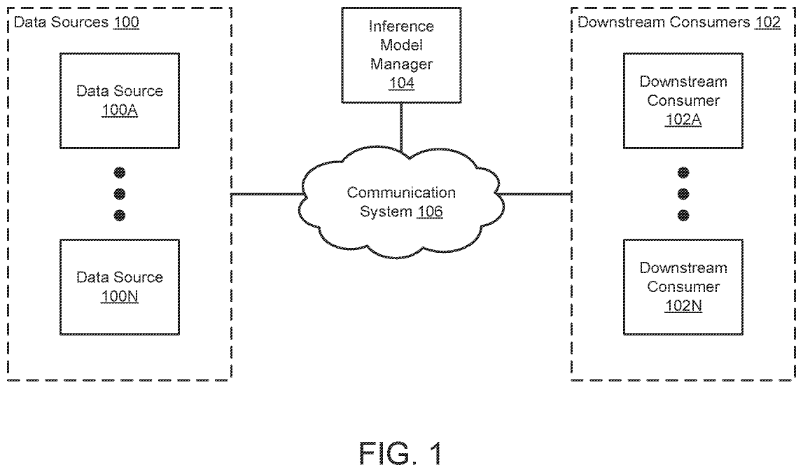

Turning to FIG. 1, a block diagram illustrating a system in accordance with an embodiment is shown. The system shown in FIG. 1 may provide computer-implemented services that may utilize inference models as part of the provided computer-implemented services.

The inference models may be artificial intelligence (AI) models and may include, for example, linear regression models, neural network models, time series models, and/or other types of inference generation models. The inference models may be used for various purposes. For example, the inference models may be trained to recognize patterns, automate tasks, and/or make decisions. The inference models may include predictive models, and the predictive models may be used to predict future outcomes (e.g., based on historical time series data).

The computer-implemented services may include any type and quantity of computer-implemented services. The computer-implemented services may be provided by, for example, data sources 100, downstream consumers 102, inference model manager 104, and/or any other type of devices (not shown in FIG. 1). Any of the computer-implemented services may be performed, at least in part, using inference models and/or inferences (e.g., predictions) obtained with the inference models. For example, the computer-implemented services may include the generation of future outcome predictions based on ingest data (e.g., input data).

Data sources 100 may include any number of data sources (100A-100N) that may obtain (i) training data usable to train inference models, and/or (ii) input data that is ingestible into trained inference models to obtain corresponding inferences. The inferences generated by the inference models may be provided to downstream consumers 102 for downstream use.

Downstream consumers 102 may include any number of data processing systems (e.g., devices) that a user may utilize to provide, all or a portion, of the computer-implemented services. When doing so, downstream consumers 102 may consume inferences obtained by inference model manager 104 (and/or other entities using inference models managed by inference model manager 104). For example, downstream consumers 102 may consume and rely on the future outcome predictions in order to make business decisions.

However, an inference model may be sensitive to anomalies present in ingest data used to generate predictions, which may affect the reliability of the predictions. For example, the anomalies present in the ingest data may be due to and/or may reflect the existence of anomaly conditions such as unexpected changes in war, inflation, famine, etc. If the inference model is sensitive to these types of anomalies, then the predictions generated using the inference model may be unreliable (e.g., of poor quality). For example, the predictions may be made out of context of the anomaly conditions (e.g., the inference model may not take into account the presence of the anomaly conditions when generating the predictions) thereby reducing a quality and/or reliability of the predictions by downstream consumers 102. Thus, when the anomaly conditions exist, desired computer-implemented services may not be provided and/or downstream consumers 102 may be negatively impacted by an unavailability of reliable predictions.

Consider a scenario in which an inference model is trained to predict a number of widgets that a factory should produce per unit time. The inference model input data may include time series data usable to generate such a prediction. For example, the input data may include quantities of components required to manufacture the widgets (e.g., component availability over time), forecasted demand for the widget for future time periods, contracted quantities of components from suppliers for future time periods, and/or other data. Some portions of the time series data (e.g., time frames) may present as anomalous due to existing anomaly conditions (e.g., war).

For example, during a time of war, demand for the widget may be significantly reduced compared to the demand during times without war. As a result, the input data may indicate lower demand values than expected by the inference model (e.g., based on some threshold). Without contextual information regarding the anomaly condition (war) present in the input data, the inference model may, for example, reject the lower demand values (e.g., the inference model may discard any anomalous values or cap (e.g., adjust, based on a maximum threshold) the anomalous values. As a result, the prediction made by the inference model may not reflect the anomaly condition, making the prediction unreliable and/or untrustworthy.

To increase a likelihood of obtaining reliable predictions using the inference models, anomaly conditions associated with ingest data may be taken into account during inferencing in order to obtain contextualized predictions. The contextualized predictions may be obtained in consideration of the anomaly conditions and may therefore facilitate the desired computer-implemented services.

In general, embodiments disclosed herein may provide methods, systems, and/or devices for managing inference models that may be sensitive to anomaly conditions so that the predictions obtained using the inference models are more likely to be reliable in view of the anomaly conditions. By doing so, the system may be more likely to provide the desired computer-implemented services due to an increased likelihood of providing relevant predictions.

To manage an inference model, the system of FIG. 1 may (i) obtain input data (e.g., ingest data, via any of data sources 100) to generate a prediction using the inference model, (ii) obtain, using an anomaly classifier, an anomaly condition associated with a portion of the input data, (iii) ingest the anomaly condition into an attention mechanism of the inference model to obtain an updated inference model (e.g., the updated inference model being capable of generating predictions in the context of the anomaly condition using the input data), and/or (iv) obtain the prediction (e.g., a contextualized prediction) using the updated inference model and the input data.

To provide the above-mentioned functionality, inference model manager 104 may manage any number of inference models. For example, inference model manager 104 may (i) oversee training processes to obtain trained inference models, (ii) manage inference model repositories, (iii) oversee inference generation by the inference models, (iv) perform remedial actions when one or more inference models does not perform as expected, and/or (v) perform other actions. Consequently, inferences (e.g., predictions) generated by the any number of the inference models may be collected by inference model manager 104 and/or may be provided to other entities (e.g., downstream consumers 102) for use in performing the computer-implemented services.

Inference model manager 104 may manage various types of inference models. For example, inference model manager 104 may manage anomaly classifier models and/or predictive models. To obtain anomaly conditions associated with ingest data, inference model manager 104 may manage training of an anomaly classifier and/or may manage inference generation using a trained anomaly classifier. To obtain contextualized predictions, inference model manager 104 may facilitate cooperative use of the various types of trained inference models.

Continuing with the above example, inference model manager 104 may manage a (trained) anomaly classifier and a (trained) predictive model. The anomaly classifier may be trained to detect whether an anomaly condition is present in the input data (e.g., war), and/or other information associated with the anomaly condition (in aggregate, “attention data”).

The attention data may be used, for example, to increase or decrease emphasis on specific features and/or portions of the input data based on their relevance in view of the anomaly condition. To do so, the attention data may be provided to the predictive model (e.g., via an attention mechanism of the predictive model) in order to update (weights of) the predictive model. As a result, the updated predictive model may be more likely to generate a reliable prediction (e.g., a contextualized prediction) based on the input data.

To perform the above-mentioned functionality, the system of FIG. 1 may include data sources 100, downstream consumers 102, inference model manager 104, and/or other entities. Data sources 100, downstream consumers 102, inference model manager 104, and/or any other type of devices not shown in FIG. 1 may perform all, or a portion of the computer-implemented services independently and/or cooperatively.

Data sources 100 may include any number and/or type of data sources. Data sources 100 may include, for example, data collectors, data aggregators, data repositories, and/or any other entity responsible for providing input data to inference models.

Downstream consumers 102 may provide, all or a portion, of the computer-implemented services. When doing so, downstream consumers 102 may obtain inferences obtained by inference model manager 104 (and/or other entities using inference models managed by inference model manager 104). Downstream consumers 102 may use the inferences to manage conditions (e.g., related to the anomaly conditions) that may impact decision-making and/or computer-implemented services that may be provided based on the inferences.

For example, a user of downstream consumers 102 may be a business decision maker responsible for determining a number of widgets to be produced by a factory at a future point in time. Inference model manager 104 (and/or another entity) may provide the inferences to downstream consumers 102 and the business decision maker may utilize the inferences when determining the number of widgets.

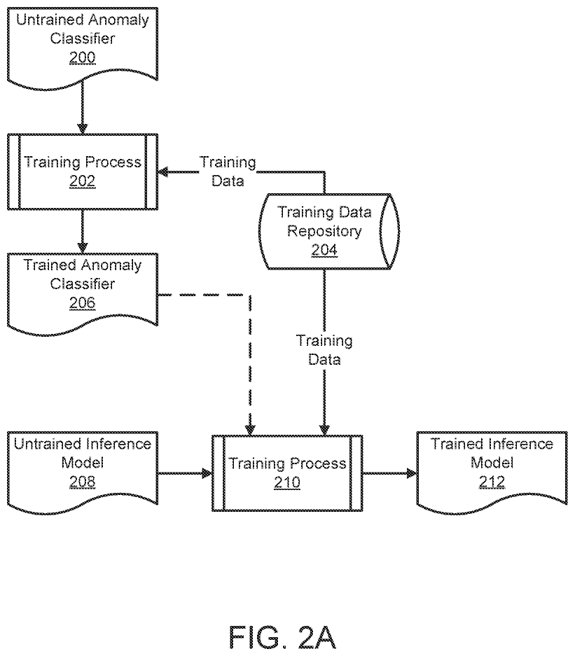

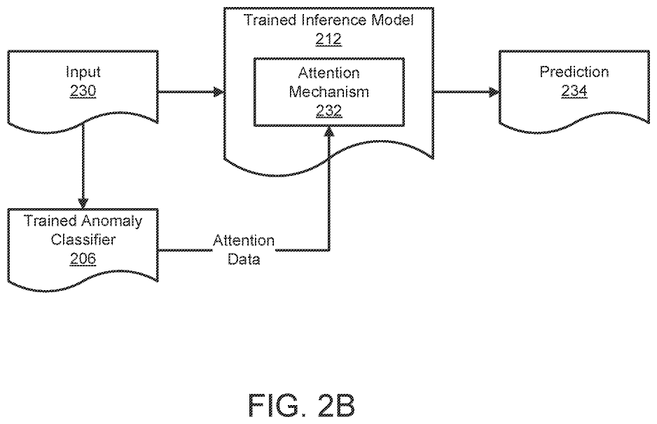

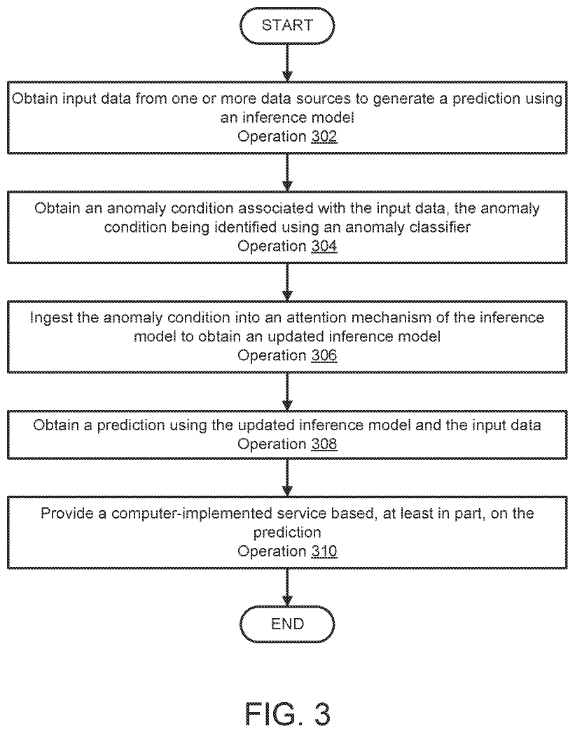

When performing its functionality, one or more of data sources 100, downstream consumers 102, and inference model manager 104 may perform all, or a portion, of the methods and/or actions shown in FIGS. 2A-3.

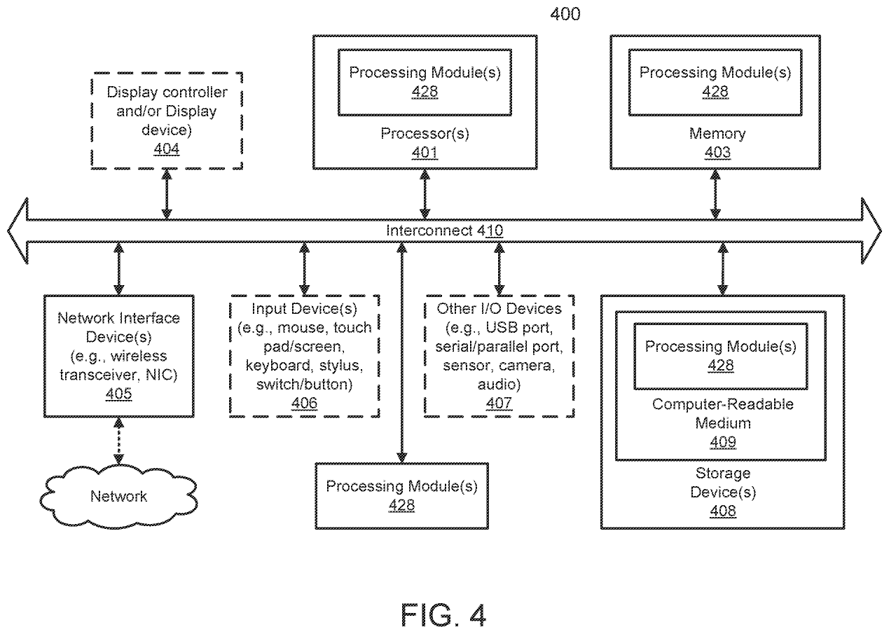

Any of data sources 100, downstream consumers 102, and inference model manager 104 may be implemented using a computing device (e.g., a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106.

Communication system 106 may include one or more networks that facilitate communication between any number of components. The networks may include wired networks and/or wireless networks (e.g., and/or the Internet). The networks may operate in accordance with any number and types of communication protocols (e.g., such as the internet protocol). Communication system 106 may be implemented with one or more local communications links (e.g., a bus interconnecting a processor of inference model manager 104 and any of the data sources 100, and downstream consumers 102).

While illustrated in FIG. 1 as included a limited number of specific components, a system in accordance with an embodiment may include fewer, additional, and/or different components than those illustrated therein.

The system described in FIG. 1 may be used to manage inference models that may be sensitive to anomaly conditions in order to improve availability and/or quality of computer-implemented services provided to consumers of the computer-implemented services. The following processes described in FIGS. 2A-2B may be performed by the system in FIG. 1 when providing this functionality.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 200, 206, etc.) is used to represent data structures, a second set of shapes (e.g., 202, 210, etc.) is used to represent processes performed using and/or that generate data, and a third set of shapes (e.g., 204) is used to represent large scale data structures such as databases.

Turning to FIG. 2A, a first data flow diagram in accordance with an embodiment is shown. The first data flow diagram may illustrate data used in and data processing performed during training of inference models. In the example shown in FIG. 2A, a classification model (e.g., an anomaly classifier) may be trained to identify anomalies in ingest data and/or classify the anomalies by anomaly condition, and an inference model (e.g., a predictive model) may be trained to generate predictions in context of the anomaly conditions based on the ingest data.

To train the anomaly classifier, a management entity (e.g., inference model manager 104) may facilitate performance of training process 202. During training process 202, untrained anomaly classifier 200 may be trained using training data. Untrained anomaly classifier 200 may include inference model data such as model architecture data, hyperparameter data, and/or other inference model data.

The training data used to train untrained anomaly classifier 200 may be obtained from any number of data sources (e.g., data sources 100). The training data may be curated (e.g., processed, labeled) before being stored in training data repository 204. Training data repository 204 may store various types of training data for various training purposes. The training data may define an association between two pieces of information (e.g., a sample input associated with a sample output, the pair being labeled data). For example, input samples may include different types of patterns (e.g., statistical anomalies) that may be found in different types of input data (e.g., time series data), and the output samples may include different types of attention data (e.g., anomaly conditions and/or other data associated with the anomaly conditions).

During training process 202, a supervised learning method may be implemented in order to train untrained anomaly classifier 200. A supervised learning method may be used during training process 202 by virtue of the anomaly conditions being predefined and associated with different types of data anomalies (e.g., specified in labeled training data). Large numbers of associations may be trained into untrained anomaly classifier 200 (e.g., using various combinations of input samples and output samples from the training data). Training untrained anomaly classifier 200 may include updating model parameters of the untrained anomaly classifier 200 based on the associations specified by the training data. For example, depending on the type of inference model being trained, values of model parameters such as coefficient, weight, bias, and/or cluster centroid values of the inference model may be updated based on the training data associations.

As a result of training process 202, parameters (e.g., weights, biases) of untrained anomaly classifier 200 may be updated to obtain trained anomaly classifier 206 based on the training data associations (e.g., using any type of supervised learning methods known in the art). Trained anomaly classifier 206 may therefore be trained to associate a desired output sample of the training data with an input sample of the training data. For example, trained anomaly classifier 206 may analyze ingest data that is different from the training data and identify (i) an anomaly condition present in portions of the ingest data, and/or (ii) information associated with the anomaly condition, such as ingest data feature or segment identifiers, soft weights, and/or other information usable to train an inference model to generate predictions in the context of the anomaly condition. The output of trained anomaly classifier 206 may include data used by an attention mechanism of the inference model (e.g., attention data).

To train the inference model, training process 210 may be performed. For example, the management entity (e.g., inference model manager 104) may facilitate training process 210. Untrained inference model 208 may include inference model data. For example, untrained inference model 208 may include a time series model such as an autoregressive integrated moving average (ARIMA) model and/or any other type of time series model. The architecture of untrained inference model 208 may include a transformer model architecture. For example, untrained inference model 208 may be based on an architecture that transforms components (e.g., features, segments) of an input sequence of data into an output sequence of data by tracking relationships between the input and output sequence components in order to learn context and/or meaning of the data.

Training process 210 may be similar to training process 202. In order to train untrained inference model 208, training process 210 may use (i) training data from training data repository 204, and/or (ii) supplementary input (e.g., attention data, from trained anomaly classifier 206).

The training data used to train untrained inference model 208 may include different features and/or associations than the training data used in training process 202. For example, the training data used to train untrained inference model 208 may include associations between patterns found in the training data and a desired output of the inference model. The desired output of the inference model may include information usable to manage a condition impacting a business at a future point in time. For example, the desired output may include a prediction regarding various widget production rates, a change in availability of supply of a product from a supplier, etc.

The supplementary input may include output from trained anomaly classifier 206 and/or other data. For example, output (e.g., anomaly conditions and/or other information) from trained anomaly classifier 206 may be provided to an attention mechanism of untrained inference model 208 (not shown). The attention mechanism may be trained (e.g., as part of training process 210, as part of another training process not included in training process 210) to modify weights of untrained inference model 208 so that predictions generated by trained inference model 212 reflect (e.g., are contextualized with respect to) the anomaly conditions present in the training data.

During training process 210, parameters (e.g., weights, biases) of untrained inference model 208 may be updated based on training data associations and/or supplementary input to an attention mechanism of untrained inference model 208 in order to obtain trained inference model 212. Trained anomaly classifier 206 and trained inference model 212 may be obtained (e.g., trained) simultaneously, independently, and/or using some combination thereof.

In some training situations, training process 210 may ingest untrained anomaly classifier 200 (not shown). For example, untrained anomaly classifier 200 and untrained inference model 208 may be trained simultaneously (e.g., weights of both untrained anomaly classifier 200 and untrained inference model 208 may be modified during the same training process.

In another example, untrained inference model 208 may be trained independently from trained anomaly classifier 206 (e.g., without supplementary input from trained anomaly classifier 206). The independently trained inference models may be combined in some manner for later use (e.g., during an inferencing process).

Training processes 202 and 210 may generate any number of different types and/or sizes of inference models. The inference models may, for example, be implemented with artificial neural networks, decision trees, regression analysis, and/or any other type of model usable for learning purposes.

Once trained, trained inference model 212 may associate a contextualized output sample of the training data with an input sample of the training data (e.g., based on supplementary input from trained anomaly classifier 206). By doing so, trained inference model 212 may be able to generate predictions based on ingest data in the context of anomaly conditions present in the ingest data.

Turning to FIG. 2B, a second data flow diagram in accordance with an embodiment is shown. The second data flow diagram may illustrate data used in and data processing performed when generating predictions using inference models.

To generate the predictions, an inferencing process may be performed. During the inferencing process, ingest data may be input to one or more inference models. In the example shown in FIG. 2B, the ingest data may include input 230, and the inference models may include trained inference model 212 and trained anomaly classifier 206. Input 230 may be provided to both trained anomaly classifier 206 and trained inference model 212 simultaneously and/or at different times.

Input 230 may be obtained from various data sources (e.g., data sources 100) and may include time series data (e.g., input samples of time series data) usable for generating predictions (e.g., prediction 234). As a result of input 230 being collected from various data sources, portions of input 230 may include anomalies (e.g., unexpected information). The anomalies may be present in input 230 for various reasons. For example, an anomaly may be present in input 230 due to low quality data (e.g., sparse data, irrelevant data), malicious data (e.g., data that may be intentionally misleading), and/or anomaly conditions (e.g., changes in political conditions, economic conditions, socio-economic conditions, climate conditions).

Some anomalies may negatively affect the desired outcome of the inferencing process (e.g., the reliability of the prediction), and therefore may be managed accordingly, whereas anomalies present due to anomaly conditions may be managed based on their relationship with the desired outcome. For example, low quality data and malicious data may be identified, removed, ignored, substituted (e.g., interpolated, sourced elsewhere), etc. However, data anomalies in input 230 that reflect an anomaly condition may be taken into account during the inferencing process as they may provide context to predictions obtained during the inferencing process.

For example, the anomaly conditions may include (i) war, (ii) inflation, (iii) pestilence, (iv) famine, (v) poverty, (vi) overabundance of material comfort, (v) material scarcity, (vi) supply chain failure, and/or (vii) other types of conditions that may cause anomalous (e.g., unexpected, atypical) samples to be present in the ingest data (e.g., input 230). For example, the anomaly conditions may reflect unexpected changes in: war, inflation, pestilence, famine, poverty, material scarcity, and/or supply chain function (e.g., when compared to historical rates thereof). Thus, although the anomaly conditions may present as anomalous samples, they may provide additional information (e.g., context) usable in the inferencing process to improve the reliability of the prediction.

To generate predictions in context of the anomaly condition, input 230 may be input to and analyzed by trained anomaly classifier 206. Trained anomaly classifier 206 may detect an anomaly condition and/or obtain (e.g., generate) attention data regarding the detected anomaly condition. The attention data may be used to update (parameters of) trained inference model 212. For example, the attention data may include (i) a key vector (e.g., the classified anomaly condition) (ii) a value vector (e.g., an association between the identified anomaly condition and model parameters, such as weights), and/or (iii) other information regarding the anomaly condition (e.g., feature identifiers, time frames for time series data affected by the anomaly condition).

To update trained inference model 212, the attention data may be provided to attention mechanism 232 of trained inference model 212. Attention mechanism 232 may manage and/or facilitate modification of parameters of trained inference model 212 based on an evaluation of the attention data. For example, trained inference model 212 may include a neural network, and weights of trained inference model 212 may be adjusted to modify importance of different features of input 230 (e.g., some features may be prioritized or deprioritized) according to the attention data. To do so, attention mechanism 232 may impact operation of (i) an input layer of trained inference model 212 (e.g., weights associated with the input layer may be modified), and/or (ii) at least one hidden layer of trained inference model 212 (e.g., weights associated with layers deeper than the input layer may be modified). Although shown as part of trained inference model 212, attention mechanism 232 may be implemented as a separate neural network.

Once updated, trained inference model 212 may ingest input 230 and generate prediction 234 based on the modified weights so that prediction 234 is made in context of the anomaly condition present in input 230. Prediction 234 may be provided to a downstream consumer (e.g., of downstream consumers 102) as part of a computer-implemented service. The downstream consumer may use prediction 234 and/or other information to provide computer-implemented services.

Prediction 234 may be more reliable and/or trustworthy when used by the downstream consumer than a prediction obtained out of context of the anomaly condition. For example, prediction 234 may be more reliable for managing (i) changes in demand of a product provided by a business, (ii) changes in availability of a material from a supplier, and/or (iii) other changes related to the anomaly condition that may impact an entity (e.g., a population, a business, a country) at a future point in time.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flows shown in FIGS. 2A-2B, inference models may be trained to identify and adapt to anomaly conditions present in ingest data. The trained inference models may be used to obtain predictions in context of the anomaly conditions. The (contextualized) predictions may be more likely to be trusted and/or relied upon by downstream consumers of the predictions (e.g., downstream consumers 102), thereby improving computer-implemented services that are provided based on the predictions.

Turning to FIG. 3, a flow diagram illustrating a method in accordance with an embodiment is shown. The flow diagram may illustrate various operations performed while managing an inference model in view of anomaly conditions that may be present in ingest data for the inference model.

At operation 302, input data may be obtained from one or more data sources to generate a prediction using the inference model. The input data may be obtained by (i) receiving the input data from another entity (e.g., from the one or more data sources), (ii) reading the input data from storage, (iii) generating the input data, and/or (iv) via other methods. For example, generating the input data may include curating (e.g., processing) raw data obtained from the one or more data sources. The input data may include ingest data that may be usable by the inference model to obtain (e.g., generate) the prediction.

At operation 304, an anomaly condition associated with the input data may be obtained. The anomaly condition may be obtained by (i) receiving the anomaly condition from another entity, (ii) reading the anomaly condition from storage, (iii) identifying the anomaly condition, and/or (iv) via other methods. For example, the anomaly condition may be identified by ingesting the input data into an anomaly classifier. The anomaly classifier may be trained to (i) detect an anomaly in the input data, (ii) classify the anomaly by the anomaly condition, and/or (iii) generate other information (e.g., as part of an attention data package). For more information regarding training of an anomaly classifier, refer to the discussion of FIG. 2A.

To detect the anomaly in the input data, the anomaly classifier may use any type of anomaly detection method. For example, the detection method may include analysis of statistical representations of portions of the input data and/or pattern recognition techniques to identify pre-defined data patterns. To classify the anomaly, the anomaly classifier may interrogate a list of pre-defined anomaly conditions that may be associated with the statistical representations and/or the patterns found in the input data in order to obtain the anomaly condition.

For example, the list of (pre-defined) anomaly conditions may include war, inflation, pestilence, famine, poverty, overabundance of material comfort, material scarcity, supply chain failure, and/or other anomaly conditions. Some anomalies detected in the input data not associated with anomaly conditions may be classified otherwise (e.g., as low-quality data or malicious). The anomaly condition may be associated with a portion of the input data (e.g., for time series data, the anomaly condition may be associated with a time frame). The anomaly condition may be included as a portion of attention data obtained by the anomaly classifier based on the input data. For more information regarding anomaly conditions, refer to the discussion of FIG. 2B.

At operation 306, the anomaly condition may be ingested into an attention mechanism of the inference model to obtain an updated inference model. The anomaly condition may be ingested into the attention mechanism by providing an attention data package that includes the anomaly condition to the inference model. For example, the inference model may include a neural network. The neural network may be trained using a transformer architecture so that the attention mechanism has functionality for receiving attention data and managing updates to parameters of the neural network based on the attention data during inferencing. For more information regarding training of transformer models, refer to the discussion of FIG. 2A.

Ingesting the anomaly condition (e.g., attention data) may include modifying at least one weight of the neural network based on the anomaly condition (e.g., attention data) to obtain an updated inference model. The weight(s) may be modified based on information included in the attention data by (i) identifying a connection between nodes of the neural network and an existing weight of the connection, (ii) updating the existing weight with a new weight for the connection specified by the attention data, and/or (iii) by other methods.

Modifying the weight(s) may include (i) modifying functionality of a regressor of the inference model, and/or (ii) modifying importance of different features of the input data on predictions generated by the updated inference model. The weight(s) may be modified by the attention mechanism at any layer of the neural network (e.g., depending on which layer(s) is/are used for attention). For example, operation of an input layer of the neural network may be impacted by the weight modification, and/or the operation of a hidden layer of the neural network may be impacted by the weight modification. By modifying the weight(s) according to the anomaly condition, the updated inference model may be able to generate a prediction that is contextualized with respect to the anomaly condition. For more information regarding inferencing using a transformer model, refer to the discussion of FIG. 2B.

At operation 308, a prediction may be obtained using the updated inference model and the input data. The prediction may be obtained by (i) receiving the prediction from another entity, (ii) reading the prediction from storage, (iii) generating the prediction, and/or (iv) via other methods. For example, the prediction may be generated by ingesting the input data into the updated inference model. The prediction may include a contextualized prediction (e.g., generated in context of the anomaly condition).

At operation 310, a computer-implemented service may be provided based, at least in part, on the prediction. The computer-implemented service may be provided by (i) transmitting the prediction to an entity (e.g., a downstream consumer) for downstream use, (ii) using the prediction and/or other information to make decisions (e.g., political decisions, business decisions, economic decisions), and/or (iii) by other methods.

For example, the prediction may include information usable to manage a condition impacting a business at a future point in time. The condition impacting the business at the future point in time may include a change in availability of supply of a product from a supplier. For example, the input data may indicate that the supply of the product has decreased due to material scarcity (and not due to poor quality data and/or other factors that may affect material availability), and the prediction may reflect this information. Thus, the prediction may be used downstream in forecasting and/or planning for the business.

The method may end following operation 310.

Thus, as illustrated above, embodiments disclosed herein may provide systems and methods usable to manage inference models in view of anomaly conditions that may be present in ingest data. By doing so, the quality (e.g., reliability, trustworthiness, usability) of predictions generated by the inference models based on the ingest data may be more likely to be improved, which may result in improved quality of computer-implemented services. Accordingly, the disclosed process provides for an improved method for managing the inference models.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing an inference model, the method comprising:
obtaining input data from one or more data sources to generate a prediction using the inference model;
obtaining an anomaly condition associated with the input data, the anomaly condition being identified using an anomaly classifier;
ingesting the anomaly condition into an attention mechanism of the inference model to obtain an updated inference model;
obtaining the prediction using the updated inference model and the input data; and
providing a computer-implemented service based, at least in part, on the prediction.

2. The method of claim 1, wherein the anomaly condition comprises one selected from a group of anomaly conditions consisting of:
war;
inflation;
pestilence;
famine;
poverty;
overabundance of material comfort;
material scarcity; and
supply chain failure.

3. The method of claim 1, wherein the anomaly classifier is trained to detect an anomaly in the input data and/or classify the anomaly by the anomaly condition.

4. The method of claim 1, wherein the inference model is a neural network, the neural network being trained using a transformer architecture.

5. The method of claim 4, wherein ingesting the anomaly condition comprises:
modifying weights of the neural network based on the anomaly condition to obtain the updated inference model.

6. The method of claim 5, wherein the weights modify importance of different features of the input data on predictions generated by the updated inference model.

7. The method of claim 6, wherein modifying the weights contextualizes the prediction with respect to the anomaly condition.

8. The method of claim 5, wherein the attention mechanism impacts operation of an input layer of the neural network.

9. The method of claim 5, wherein the attention mechanism impacts operation of at least one hidden layer of the neural network.

10. The method of claim 1, wherein the prediction comprises information usable to manage a condition impacting a business at a future point in time.

11. The method of claim 10, wherein the condition impacting the business at the future point in time is a change in availability of supply of a product from a supplier.

12. A non-transitory machine-readable medium having instructions stored therein, which when executed by a processor, cause the processor to perform operations for managing an inference model, the operations comprising:
obtaining input data from one or more data sources to generate a prediction using the inference model;
obtaining an anomaly condition associated with the input data, the anomaly condition being identified using an anomaly classifier;
ingesting the anomaly condition into an attention mechanism of the inference model to obtain an updated inference model;
obtaining the prediction using the updated inference model and the input data; and
providing a computer-implemented service based, at least in part, on the prediction.

13. The non-transitory machine-readable medium of claim 12, wherein the anomaly condition comprises one selected from a group of anomaly conditions consisting of:
war;
inflation;
pestilence;
famine;
poverty;
overabundance of material comfort;
material scarcity; and
supply chain failure.

14. The non-transitory machine-readable medium of claim 12, wherein the anomaly classifier is trained to detect an anomaly in the input data and/or classify the anomaly by the anomaly condition.

15. The non-transitory machine-readable medium of claim 12, wherein the inference model is a neural network, the neural network being trained using a transformer architecture.

16. The non-transitory machine-readable medium of claim 15, wherein ingesting the anomaly condition comprises:
modifying weights of the neural network based on the anomaly condition to obtain the updated inference model.

17. A data processing system, comprising:
a processor; and
a memory coupled to the processor to store instructions, which when executed by the processor, cause the processor to perform operations for managing an inference model, the operations comprising:
obtaining input data from one or more data sources to generate a prediction using the inference model,
obtaining an anomaly condition associated with the input data, the anomaly condition being identified using an anomaly classifier,
ingesting the anomaly condition into an attention mechanism of the inference model to obtain an updated inference model,
obtaining the prediction using the updated inference model and the input data, and
providing a computer-implemented service based, at least in part, on the prediction.

18. The data processing system of claim 17, wherein the anomaly condition comprises one selected from a group of anomaly conditions consisting of:
war;
inflation;
pestilence;
famine;
poverty;
overabundance of material comfort;
material scarcity; and
supply chain failure.

19. The data processing system of claim 17, wherein the anomaly classifier is trained to detect an anomaly in the input data and/or classify the anomaly by the anomaly condition.

20. The data processing system of claim 17, wherein the inference model is a neural network, the neural network being trained using a transformer architecture.
